(19) United States
(12) Patent Application Publication
(10) Pub. No.: US 2014/0372254 A1
(43) Pub. Date: Dec. 18, 2014

(54) INFORMATION OUTPUTTING APPARATUS, INFORMATION OUTPUTTING SYSTEM, SERVER APPARATUS, INFORMATION OUTPUTTING METHOD, PROGRAM FOR INFORMATION OUTPUTTING APPARATUS AND PROGRAM FOR SERVER APPARATUS

(71) Applicant: DAI NIPPON PRINTING CO., LTD., Tokyo (JP)

(72) Inventors: Kuniaki ARAGANE, Tokyo (JP); Jiro OTA, Tokyo (JP); Kei SEKIGUCHI, Tokyo (JP)

(73) Assignee: DAI NIPPON PRINTING CO., LTD., Tokyo (JP)

(21) Appl. No.: 14/289,955

(22) Filed: May 29, 2014

(30) Foreign Application Priority Data
May 30, 2013 (JP) 2013-114282
Apr. 28, 2014 (JP) 2014-093072

(51) Int. Cl. G06Q 30/06; G09G 3/00; H04W 4/00

(52) U.S. Cl. CPC G06Q 30/0623; G06Q 30/0631; H04W 4/008; G09G 3/001; G09G 2380/04; G09G 2370/16
USPC 705/26.61

(57) ABSTRACT

An information outputting apparatus is provided which can provide various information to a user and acquire various information indicating a moving state and the like of the user without separately acquiring user identification information again.

An electronic shelf label T comprises a display 5 that displays a price and the like, a transmission/reception unit 1 that receives a customer ID for identifying a customer from a terminal apparatus P carried by the customer by wireless communication, a recording unit 2 that associates time data indicating time when the customer ID is received with the received customer ID and records the time data and the customer ID as customer/time data 21, and a transmission/reception unit 4 that associates the recorded customer/time data 21 with a sale item ID 20 and transmits the customer/time data 21 and the sale item ID 20 to the server apparatus SV.

### TECHNICAL FIELD

The present invention belongs to a technical field of an information outputting apparatus, an information outputting system, a server apparatus, an information outputting method, a program for information outputting apparatus, and a program for server apparatus. More specifically, the present invention belongs to a technical field of an information outputting apparatus, a program for information outputting apparatus, an information outputting system, an information outputting method, a server apparatus included in the information outputting system, and a program for the server apparatus, which output various useful information to a user.

### BACKGROUND ART

In general, for example, in a shop such as a grocery store, a shelf label showing sale item information such as a price and features of an item for sale is placed at a position where the item for sale is displayed. Then a customer who tries to purchase the item for sale recognizes the sale item information of the item for sale by seeing contents of the shelf label.

On the other hand, in recent years, many stores such as so-called supermarkets, which handle a huge number of items for sale and a huge number of types of items for sale, appear in, for example, urban areas. In the case of such a large-scale store, in a case of temporarily discounting items for sale for, for example, a limited-time sale, if rewriting the contents of shelf labels every time it happens, it takes huge time and effort and business opportunity will be lost. Further, in the case of the temporarily discounting items for sale as described above, if a display such as “XX % OFF!” is shown collectively for a plurality of items for sale, it is not possible to show a specific price after the discount for each item for sale so that customers can see the price at a glance, so that a situation that it is difficult for some customers to be able to know the specific price after the discount may happen.

Therefore, conventionally, a so-called “electronic shelf label” is developed. The electronic shelf label is a type of a digital signage terminal that electronically displays sale item information as the shelf label by associating the sale item information with each item for sale. In a conventional electronic shelf label, the sale item information can be rewritten by remote control, that is, for example, wireless communication. When such electronic shelf labels are used, even if the number of items for sale and the number of types of items for sale are huge, it is possible to timely and quickly rewrite and display contents of the sale item information to be presented to customers as shelf labels. As a prior art document related to such an electronic shelf label, for example, there is Patent Document 1 described below.

In a technique described in Patent Document 1, the electronic shelf label is provided with a function to switch and display a display of the price of an item for sale and a display of a so-called QR code (registered trademark) in which sale item information other than the price is coded. Thereby, the sale item information other than the price is provided to a customer by, for example, decoding the displayed QR code by a terminal apparatus at a checkout counter (hereinafter simply referred to as a “register”). More specifically, in the technique described in Patent Document 1, the electronic shelf label detects that a mobile wireless phone (hereinafter simply referred to as a “mobile phone”) that can read the QR code approaches the electronic shelf label and thereby the display of the electronic shelf label is switched from the price to the QR code. A customer in the technique described in Patent Document 1 photographs the QR code by a mobile phone carried by the customer and causes the terminal apparatus to decode a result of the photographing, so that the customer acquires the sale item information associated with the QR code. By this configuration, it is possible to present the customer with detailed sale item information that cannot be presented by the conventional shelf label due to, for example, the size of a setting place or the like.

### CITATION LIST

### Patent Document

Patent Document 1: JP 4620807 B1

### SUMMARY OF INVENTION

### Technical Problem to be Solved by the Invention

Here, a technique described in Patent Document 1 has a configuration in which the electronic shelf label detects light emitted from a light emitting unit such as a white illumination LED (light-emitting diode) included in a mobile phone, so that the electronic shelf label detects that the mobile phone approaches the electronic shelf label. However, in such a configuration, there may be a case in which the switching between the price display and the QR code display is wrongly performed (or is not performed) due to such as accuracy of a sensor which is included in the electronic shelf label and detects the emitted light.

Furthermore, there is a case that a so-called electronic paper may be used for the display on the electronic shelf label. This is because the electronic paper does not consume drive power in principle when not switching the display, so that the electronic paper has an advantage to be low power consumption as an electronic shelf label. However, the technique described in Patent Document 1 requires switching between the price display and the QR code display, so that power is consumed every time the switching is performed. Therefore, there is a problem that the advantage to be an electronic shelf label using electronic paper cannot be fully exploited.

Further, in the technique described in Patent Document 1, it is described that if time data indicating the time when the QR code is read by the mobile phone is used, a traffic line of a customer in a shop can be analyzed. However, the time data is acquired only after the mobile phone that has read the QR code is “held up over” the terminal apparatus at the register. As a result, there is a problem that it is not possible to acquire the traffic line of a customer who has searched for an article but has not purchased the article (that is, a customer who has not passed through the register and has not held up the mobile phone over the terminal apparatus installed there). Further, in the technique described in Patent Document 1, article information and the like are only unilaterally transmitted to the customer and no information is acquired from the customer, so that there is also a problem that information indicating the traffic line of the customer who has not purchased an article as described above is lost.

The present invention is made in view of the above problems and an example of an object of the present invention is to provide an information outputting apparatus, a program for information outputting apparatus, an information outputting system, an information outputting method, a server apparatus included in the information outputting system, and a program for server apparatus, which can provide various useful information to a user and acquire various information indicating a moving state and the like of the user without separately acquiring user identification information again.

### Solution to the Problem

In order to achieve the above described problems, an invention described in claim 1 is characterized in that an information outputting apparatus comprising: an outputting means, such as a display, that outputs article information related to an article; a receiving means, such as a transmission/reception unit, that receives user identification information for identifying a user, who receives an output of the article information, from a user apparatus of the user by wireless communication; a storing means, such as a recording unit, that stores time information indicating time when the user identification information is received and the received user identification information in association with each other; and a transmitting means, such as a transmission/reception unit, that associates the time information and the user identification information, which are stored in association with each other, with article identification information for identifying the article and outputs the time information, the user identification information, and the article identification information to outside.

In order to achieve the above described problems, an invention described in claim 13 is characterized in that a program for information outputting apparatus, the program causing a computer included in the information outputting apparatus comprising an outputting means, such as a display, that outputs article information related to an article, a receiving means, such as a transmission/reception unit, that receives user identification information for identifying a user, who receives an output of the article information, from a user apparatus of the user by wireless communication, and a storing means such as a recording unit, to function as: a storing control means that causes the storing means to store time information indicating time when the user identification information is received and the received user identification information in association with each other; and a transmitting means that associates the time information and the user identification information, which are stored in association with each other, with article identification information for identifying the article and outputs the time information, the user identification information, and the article identification information to outside.

According to the invention described in claim 1 or 13, while the article information is outputted, the user identification information of the user who receives the output of the article information is received from the user apparatus by wireless communication, and the time information indicating the time when the user identification information is received and the user identification information are stored in association with each other. Then, the time information and the user identification information which are stored in association with each other are associated with the article identification information for identifying the article, and the time information, the user identification information, and the article identification information are outputted to the outside. Therefore, it is possible to provide various information to the user identified by the user identification information by using the acquired user identification information and the like by acquiring the time information, the user identification information, and the article identification information from a plurality of information outputting apparatuses while associating the time information, the user identification information, and the article identification information with each other in the outside. Further, the time information, the user identification information, and the article identification information can be associated with each other and acquired in the outside, so that it is possible to acquire various information indicating a moving state and the like of the user in the outside without separately acquiring the user identification information again.

In order to achieve the above described problems, an invention described in claim 2 is characterized in that the information outputting apparatus according to claim 1, wherein the information outputting apparatus is a shelf label provided to a display shelf on which the article related to the outputted article information is displayed, and the receiving means receives the user identification information from the user apparatus of the user who moves in front of the display shelf.

According to the invention described in claim 2, in addition to the action of the invention described in claim 1, the information outputting apparatus is a shelf label and receives the user identification information from the user apparatus of the user who moves in front of the display shelf, so that it is possible to effectively provide various information to, for example, a user coming for shopping. Further, it is possible to associate the user identification information of the user who passes through in front of the display shelf with the time information indicating the time of the passing, store the user identification information and the time information, further associate the user identification information and the time information with the article identification information, and transmit the user identification information, the time information, and the article identification information to the outside.

In order to achieve the above described problems, an invention described in claim 3 is characterized in that the information outputting apparatus according to claim 1 or 2, wherein the receiving means receives the user identification information from the user apparatus by the wireless communication compliant with NFC (Near Field Communication) standard.

According to the invention described in claim 3, in addition to the action of the invention described in claim 1 or 2, the user identification information is received from the user apparatus by the wireless communication compliant with the NFC standard, so that it is possible to receive the user identification information with an inexpensive and simple configuration by using a general standard.

In order to achieve the above described problems, an invention described in claim 4 is characterized in that the information outputting apparatus according to any one of claims 1 to 3, wherein the outputting means outputs the article information by using an electronic paper.

According to the invention described in claim 4, in addition to the action of the invention described in any one of claims 1 to 3, the outputting means is an outputting means that outputs the article information by using an electronic paper, so that it is possible to effectively utilize advantages of the electronic paper by minimizing rewriting of the article information in the outputting means by providing various other information not through the outputting means.

In order to achieve the above described problems, an invention described in claim 5 is characterized in that an information outputting system comprising: the information outputting apparatus according to any one of claims 1 to 4 and a server apparatus, wherein the server apparatus comprises a server apparatus receiving means, such as a transmission/reception unit, that receives the time information, the user identification information, and the article identification information which are transmitted from the information outputting apparatus, a server apparatus storing means, such as a recording unit, that stores the received time information, user identification information, and article identification information, a generating means, such as a processing unit, that generates provision information to be provided to the user identified by the user identification information on the basis of the stored time information, user identification information, and article identification information, and a providing means, such as a transmission/reception unit, that provides the generated provision information to the user identified by the user identification information.

According to the invention described in claim 5, the time information, the user identification information, and the article identification information, which are transmitted from the information outputting apparatus, are received and stored, the provision information is generated on the basis of the stored time information, user identification information, and article identification information, and the provision information is provided to the user, so that it is possible to efficiently provide the provision information of, for example, an article according to a preference of the user.

In order to achieve the above described problems, an invention described in claim 6 is characterized in that the information outputting system according to claim 5, wherein the generating means generates the provision information according to time intervals indicated by a plurality of the time information of the same article or a related article and a purchase state of the article on the basis of the stored time information, user identification information, and article identification information.

According to the invention described in claim 6, in addition to the action of the invention described in claim 5, the provision information according to the time intervals indicated by a plurality of time information of the same article or the related article and the purchase state of the article is generated and provided on the basis of the time information, the user identification information, and the article identification information, so that it is possible to effectively provide information according to purchase intervals or the like of the same article or the related article to the user.

In order to achieve the above described problems, an invention described in claim 7 is characterized in that the information outputting system according to claim 5 or 6, wherein the provision information is related to the article identified by the article identification information.

According to the invention described in claim 7, in addition to the action of the invention described in claim 5 or 6, the provision information is related to the article identified by the article identification information, so that it is possible to provide the provision information suitable for the user who receives the output of the article information related to the article.

In order to achieve the above described problems, an invention described in claim 8 is characterized in that the information outputting system according to any one of claims 5 to 7, wherein the generating means generates the provision information according to a purchase state of the articles of different brands of the same type on the basis of the stored time information, user identification information, and article identification information.

According to the invention described in claim 8, in addition to the action of the invention described in any one of claims 5 to 7, the provision information according to the purchase state of the articles of different brands of the same type is generated and provided on the basis of the time information, the user identification information, and the article identification information, so that it is possible to effectively provide information according to the purchase state of the articles of different brands of the same type to the user.

In order to achieve the above described problems, an invention described in claim 9 is characterized in that the information outputting system according to any one of claims 5 to 7, wherein the generating means generates the provision information according to a purchase state of the article of the same brand on the basis of the stored time information, user identification information, and article identification information.

According to the invention described in claim 9, in addition to the action of the invention described in any one of claims 5 to 7, the provision information according to the purchase state of the article of the same brand is generated and provided on the basis of the time information, the user identification information, and the article identification information, so that it is possible to effectively provide information according to the purchase state of the article of the same brand to the user.

In order to achieve the above described problems, an invention described in claim 10 is characterized in that the information outputting system according to any one of claims 5 to 7, wherein the generating means generates the provision information according to the article recommended for the user to purchase at the same time on the basis of the stored time information, user identification information, and article identification information.

According to the invention described in claim 10, in addition to the action of the invention described in any one of claims 5 to 7, the provision information according to the article recommended for the user to purchase at the same time is generated and provided on the basis of the time information, the user identification information, and the article identification information, so that it is possible to effectively provide information according to the article recommended to be purchased at the same time to the user.

In order to achieve the above described problems, an invention described in claim 11 is characterized in that the server apparatus included in the information outputting system according to any one of claims 5 to 10, the server apparatus comprising: the server apparatus receiving means; the server apparatus storing means; the generating means; and the providing means.

In order to achieve the above described problems, an invention described in claim 14 is characterized in that a program for server apparatus, the program causing a computer included in the server apparatus which is connected to the information outputting apparatus according to any one of claims 1 to 4 and which comprises a server apparatus storing means, such as a recording unit, to function as: a server apparatus receiving means that receives the time information, the user identification information, and the article identification information which are transmitted from the information outputting apparatus; a storing control means that causes the server apparatus storing means to store the received time information, user identification information, and article identification information; a generating means that generates provision information to be provided to the user identified by the user identification information on the basis of the stored time information, user identification information, and article identification information; and a providing means that provides the generated provision information to the user identified by the user identification information.

According to the invention described in claim 11 or 14, the time information, the user identification information, and the article identification information, which are transmitted from the information outputting apparatus, are received and stored, the provision information is generated on the basis of the stored time information, user identification information, and article identification information, and the provision information is provided to the user, so that it is possible to efficiently provide the provision information of, for example, an article according to a preference of the user.

In order to achieve the above described problems, an invention described in claim 12 is characterized in that an information outputting method included in an information outputting system comprising an information outputting apparatus comprising an outputting means, such as a display, that outputs article information related to an article and a storing means such as a recording unit, and a server apparatus comprising a server apparatus storing means, the information outputting method comprising: a receiving step of receiving user identification information for identifying a user, who receives an output of the article information, from a user apparatus of the user by wireless communication, in the information outputting apparatus; a storing step of causing the storing means to store time information indicating time when the user identification information is received and the received user identification information in association with each other, in the information outputting apparatus; a transmitting step of associating the time information and the user identification information, which are stored in association with each other, with article identification information for identifying the article and outputting the time information, the user identification information, and the article identification information to the server apparatus, in the information outputting apparatus; a server apparatus receiving step of receiving the time information, the user identification information, and the article identification information which are transmitted from the information outputting apparatus, in the server apparatus; a server apparatus storing step of causing the server apparatus storing means to store the received time information, user identification information, and article identification information, in the server apparatus; a generating step of generating provision information to be provided to the user identified by the user identification information on the basis of the stored time information, user identification information, and article identification information, in the server apparatus; and a providing step of providing the generated provision information to the user identified by the user identification information, in the server apparatus.

According to the invention described in claim 12, in the information outputting apparatus, while the article information is outputted, the user identification information of the user who receives the output of the article information is received from the user apparatus by wireless communication, and the time information indicating the time when the user identification information is received and the user identification information are stored in association with each other. Then, the time information and the user identification information which are stored in association with each other are associated with the article identification information for identifying the article, and the time information, the user identification information, and the article identification information are outputted to the server apparatus. Then, in the server apparatus, the time information, the user identification information, and the article identification information, which are transmitted from the information outputting apparatus, are received and stored, the provision information is generated on the basis of the stored time information, user identification information, and article identification information, and the provision information is provided to the user. Therefore, it is possible to efficiently provide the provision information and the like of, for example, for example, an article according to a preference of the user to the user identified by the user identification information by using the acquired user identification information and the like by acquiring the time information, the user identification information, and the article identification information from a plurality of information outputting apparatuses in the server apparatus while associating the time information, the user identification information, and the article identification information with each other. Further, the time information, the user identification information, and the article identification information can be associated with each other and acquired in the server apparatus, so that it is possible to acquire various information indicating a moving state and the like of the user in the server apparatus without separately acquiring the user identification information again.

### Effects of the Invention

According to the present invention, while the article information is outputted, the user identification information of the user who receives the output of the article information is received from the user apparatus by wireless communication, and the time information indicating the time when the user identification information is received and the user identification information are stored in association with each other. Then, the time information and the user identification information which are stored in association with each other are associated with the article identification information for identifying the article, and the time information, the user identification information, and the article identification information are outputted to the outside.

Therefore, it is possible to provide various information to the user identified by the user identification information by using the acquired user identification information and the like by acquiring the time information, the user identification information, and the article identification information from a plurality of information outputting apparatuses while associating the time information, the user identification information, and the article identification information with each other in the outside. Further, the time information, the user identification information, and the article identification information can be associated with each other and acquired in the outside, so that it is possible to acquire various information indicating a moving state and the like of the user in the outside without separately acquiring the user identification information again.

### BRIEF DESCRIPTION OF THE DRAWINGS

FIG. 1(a) is a block diagram showing the schematic configuration of the information providing system, and FIG. 1(b) is a block diagram showing a schematic configuration of an electronic shelf label according to the embodiment.

FIG. 2(a) is a block diagram showing the schematic configuration, and FIG. 2(b) is a diagram showing contents of a database according to the embodiment.

FIG. 3 is a block diagram showing a schematic configuration of a terminal apparatus according to the embodiment.

FIG. 4 is a flowchart showing an information providing process in the electronic shelf label according to the embodiment.

FIG. 5 is a flowchart showing an information providing process in the server apparatus according to the embodiment.

FIG. 6 is a diagram showing a first example of an information providing process according to the embodiment.

FIG. 7 is a diagram showing a second example of the information providing process according to the embodiment.

FIG. 8 is a diagram showing a third example of the information providing process according to the embodiment.

FIG. 9 is a diagram showing a fourth example of the information providing process according to the embodiment.

FIG. 10 is a diagram showing a fifth example of the information providing process according to the embodiment.

FIG. 11 is a diagram exemplifying an effect of the information providing system according to the embodiment.

FIG. 12 is a block diagram showing a schematic configuration of another example of the information providing system according to the embodiment.

### MODES FOR CARRYING OUT THE INVENTION

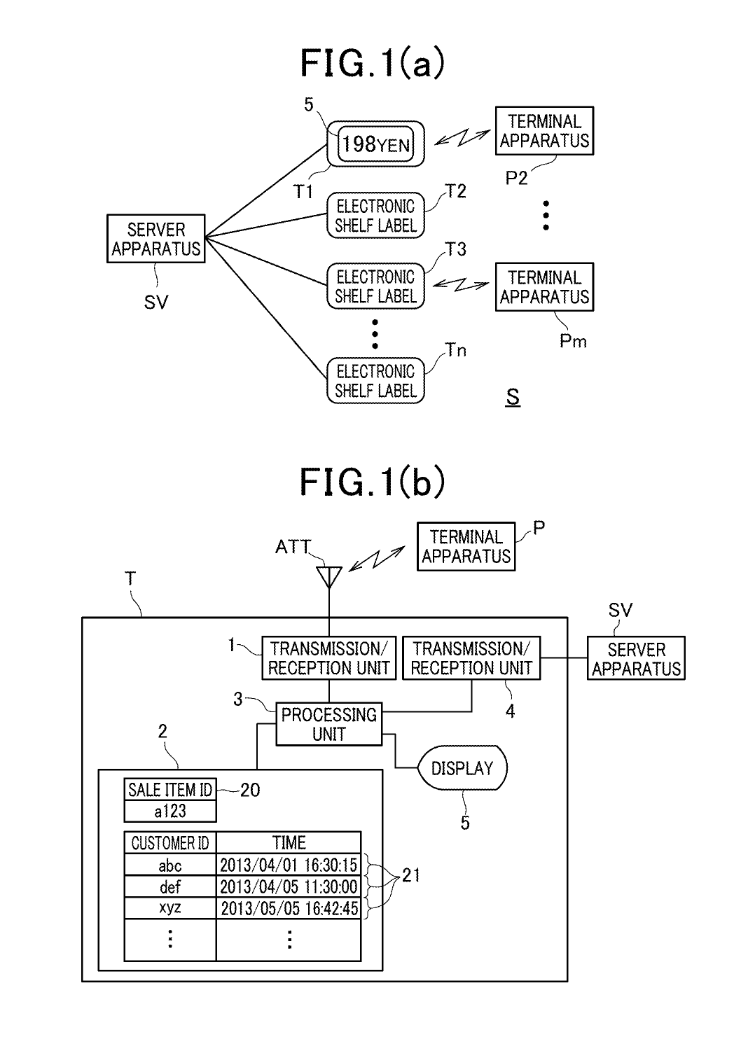

Next, an embodiment for implementing the present invention will be described with reference to FIGS. 1 to 11. The embodiment described below is an embodiment of a case in which the present invention is applied to an information providing system that provides various information to customers coming to a large-scale store such as a supermarket.

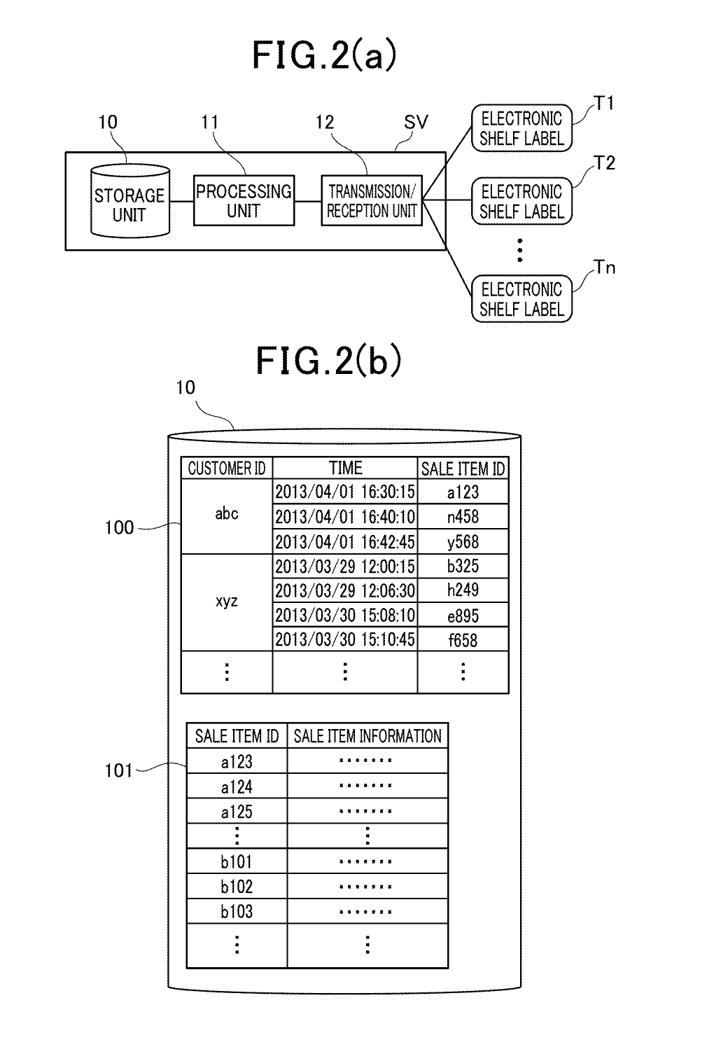

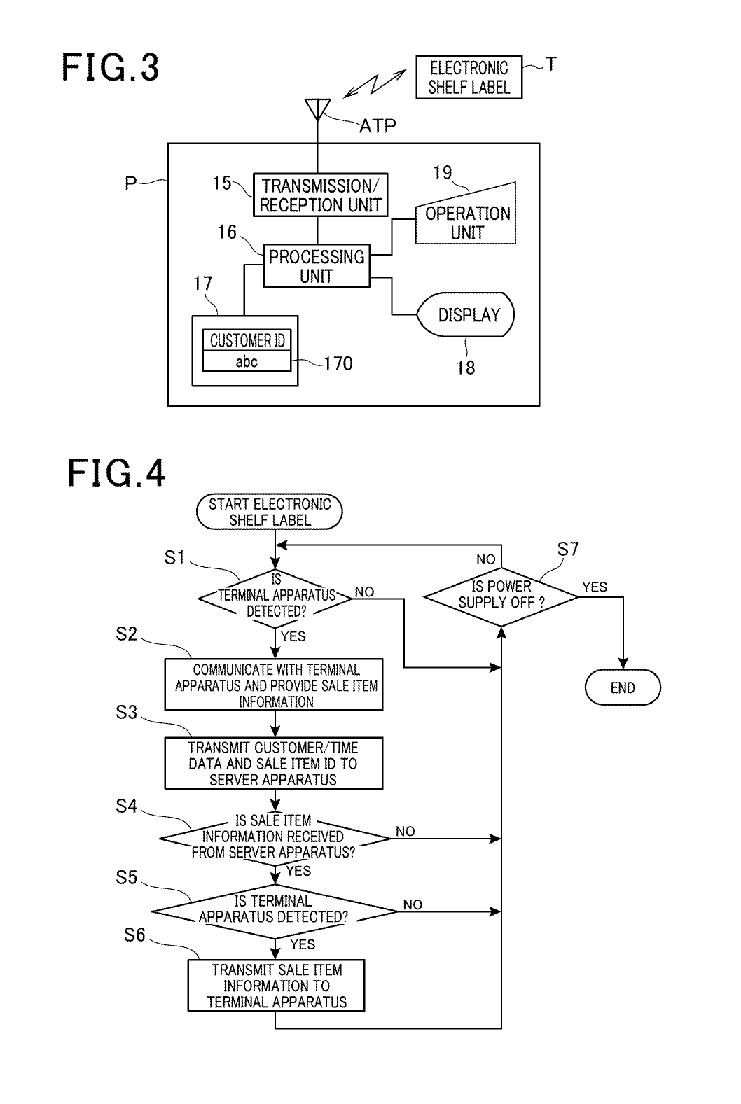

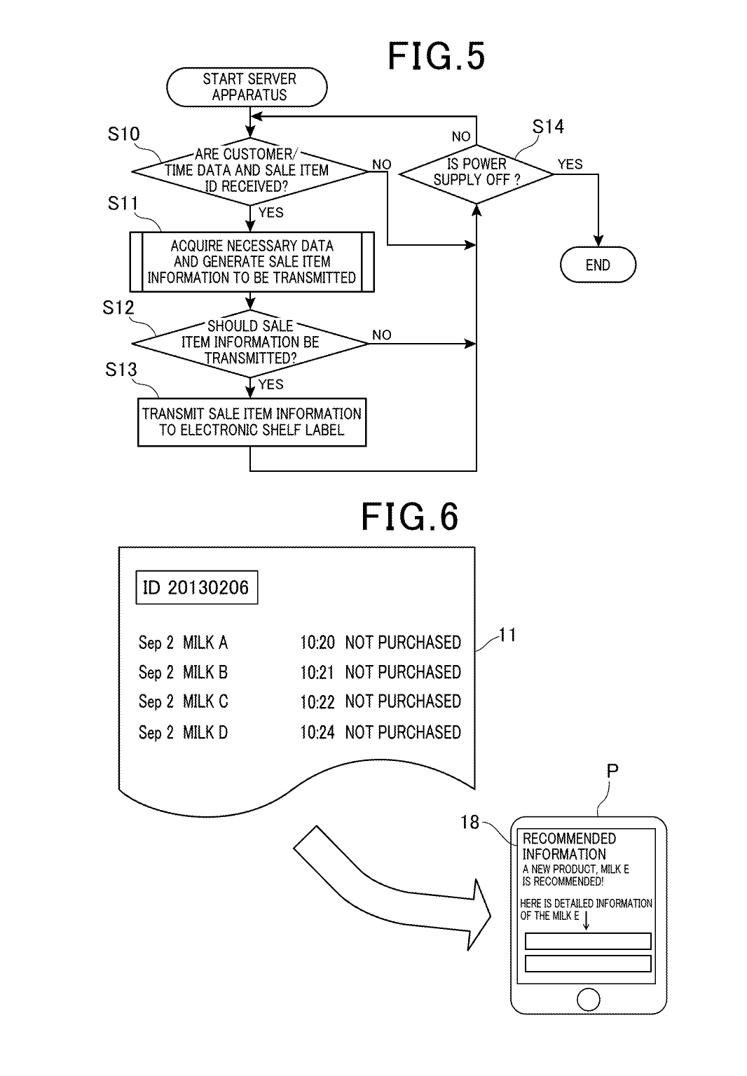

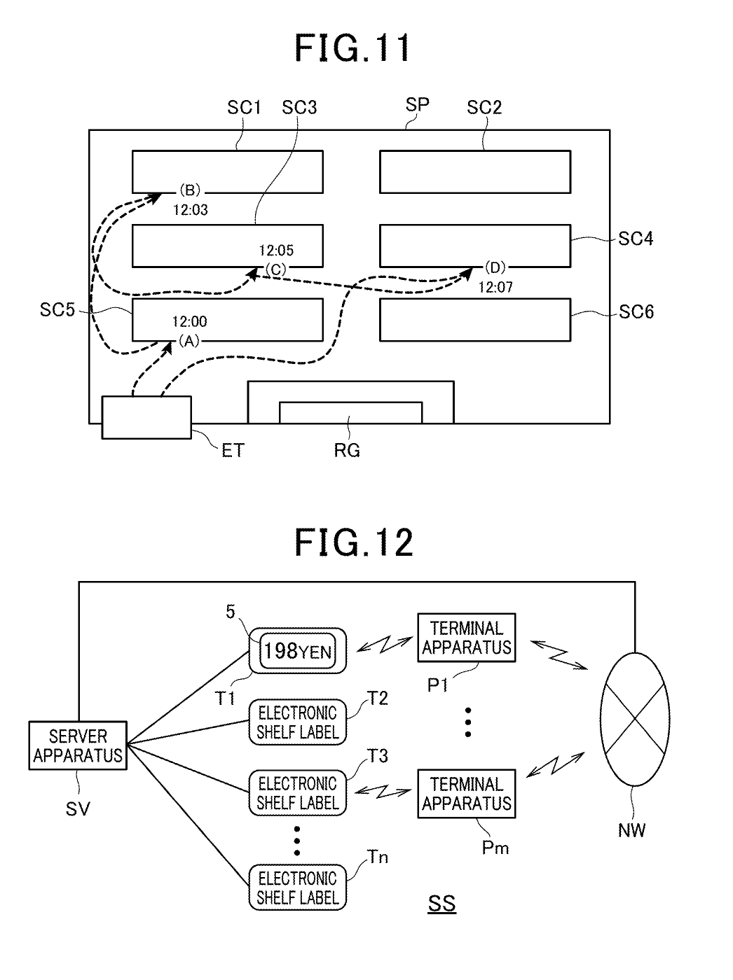

Here, FIGS. 1(a) and 1(b) are block diagrams showing schematic configurations of the information providing system and the like according to the embodiment. FIGS. 2(a) and 2(b) are block diagrams showing a schematic configuration and the like of a server apparatus according to the embodiment. FIG. 3 is a block diagram showing a schematic configuration of a terminal apparatus according to the embodiment. Further, FIG. 4 is a flowchart showing an information providing process in an electronic shelf label according to the embodiment. FIG. 5 is a flowchart showing an information providing process in the server apparatus according to the embodiment. FIGS. 6 to 10 are diagrams showing specific examples of an information providing process according to the embodiment, respectively. Further, FIG. 11 is a diagram exemplifying an effect of the information providing system according to the embodiment.

As shown in FIG. 1(a), an information providing system S according to the embodiment comprises an electronic shelf label T1, an electronic shelf label T2, an electronic shelf label T3, . . . , and an electronic shelf label Tn (n is a natural number) provided, for example, for each item for sale on a display shelf in the shop. Further, in the description below, in a case that the electronic shelf label T1, the electronic shelf label T2, the electronic shelf label T3, . . . , and the electronic shelf label Tn are commonly described, each electronic shelf label will be appropriately referred to as an “electronic shelf label T”. In addition, the information providing system S consists of a server apparatus SV connected to each electronic shelf label T and a terminal apparatus P1, . . . , and a terminal apparatus Pm (m is a natural number), which can transmit and receive information to and from each electronic shelf label T by wireless communication and each of which is carried by each customer. Further, in the description below, in a case that the terminal apparatus P1, . . . , and the terminal apparatus Pm are commonly described, each terminal apparatus will be appropriately referred to as a “terminal apparatus P”. At this time, the terminal apparatus P corresponds to an example of a “user apparatus” according to the present invention and the electronic shelf label T corresponds to an example of an “information outputting apparatus” according to the present invention.

In this configuration, each electronic shelf label T is connected to the server apparatus SV by, for example, wired or wireless communication and consists of a display 5 that displays, for example, a price of an item for sale corresponding to the electronic shelf label T. Specifically, this display 5 comprises a display element formed by, for example, an electronic paper. Further, each electronic shelf label T can transmit and receive the aforementioned information to and from the terminal apparatus P that approaches the electronic shelf label T by wireless communication. This transmission and reception of information between the terminal apparatus P and the electronic shelf label T is performed by wireless communication compliant with, for example, the NFC (Near Field Communication) standard. Further, each electronic shelf label T transmits and receives information received from the server apparatus SV to and from the terminal apparatus P located in a communicable range of the electronic shelf label T by the aforementioned wireless communication, so that the electronic shelf label T provides useful sale item information including the aforementioned price to a customer who carries the terminal apparatus P.

Next, a detailed configuration of each electronic shelf label T according to the embodiment will be described with reference to FIG. 1(b). As shown in FIG. 1(b), each of the electronic shelf labels T according to the embodiment consists of a transmission/reception unit 1 that is connected to the terminal apparatus P by wireless communication through an antenna ATT, a transmission/reception unit 4 that is connected to the server apparatus SV by, for example, wired communication, a processing unit 3 consisting of a CPU, a RAM (Random Access Memory), a ROM (Read Only Memory), and the like, a non-volatile recording unit 2 consisting of, for example, a solid-state memory, and the aforementioned display 5 consisting of, for example, an electronic paper. At this time, the display 5 corresponds to an example of an “outputting means” according to the present invention, the transmission/reception unit 1 corresponds to an example of a “receiving means” according to the present invention, the recording unit 2 corresponds to an example of a “storing means” according to the present invention, and the transmission/reception unit 4 corresponds to an example of a “transmitting means” according to the present invention.

In this configuration, the transmission/reception unit 1 transmits and receives information to and from the terminal apparatus P by the wireless communication through the antenna ATT under control of the processing unit 3. At this time, the transmission/reception unit 1 transmits and receives information to and from the terminal apparatus P that enters a range, which wireless communication waves of the transmission/reception unit 1 reach, by the wireless communication. On the other hand, the transmission/reception unit 4 transmits and receives information to and from the server apparatus SV under control of the processing unit 3. Further, the display 5 displays the sale item information such as the price under control of the processing unit 3 (see FIG. 1(a)). Then the processing unit 3 integrally controls the recording unit 2, the transmission/reception unit 1, the transmission/reception unit 4, and display 5 and performs the information providing process described later as the electronic shelf label T according to the embodiment. At this time, as part of the information providing process, when the processing unit 3 receives a customer ID for identifying a customer who carries the terminal apparatus P from other customers from the terminal apparatus P that enters the range, which wireless communication waves of the transmission/reception unit 1 reach, through the transmission/reception unit 1, the processing unit 3 associates the received customer ID with time data indicating the receiving time of the customer ID and temporarily stores the customer ID and the time data in the recording unit 2. As a result, in the recording unit 2, customer/time data 21 as illustrated in FIG. 1(b) are sequentially recorded. In addition to this, the recording unit 2 stores a sale item ID 20 for identifying an item for sale corresponding to the sale item information such as the price displayed by using the display 5 from other items for sale. Then the customer/time data 21 and the sale item ID 20 are transmitted together to the server apparatus SV through the transmission/reception unit 4 at the timing described later. Further, the customer/time data 21 that have been transmitted may be deleted from the recording unit 2 after the transmission.

Next, a detailed configuration of the server apparatus SV according to the embodiment will be described with reference to FIGS. 2(a) and 2(b). As shown in FIG. 2(a), the server apparatus SV according to the embodiment consists of a non-volatile recording unit 10 consisting of, for example, a hard disk, a processing unit 11 consisting of a CPU, a RAM, a ROM, and the like, and a transmission/reception unit 12 that is connected to each electronic shelf label T by, for example, wired communication. At this time, the transmission/reception unit 12 corresponds to each of an example of a “server apparatus receiving means” and an example of a “providing means” according to the present invention, the recording unit 10 corresponds to an example of a “server apparatus storing means” according to the present invention, and the processing unit 11 corresponds to an example of a “generating means” according to the present invention.

In this configuration, the transmission/reception unit 12 transmits and receives information to and from each electronic shelf label T under control of the processing unit 11. The processing unit 11 integrally controls the recording unit 10 and the transmission/reception unit 12 and performs the information providing process described later as the server apparatus SV according to the embodiment. At this time, as part of the information providing process, when the processing unit 11 receives the customer/time data 21 and the sale item ID 20 from each electronic shelf label T through the transmission/reception unit 12, the processing unit 11 associates the received customer/time data 21 and sale item ID 20 with each other and records them in the recording unit 10 as a customer database 100 illustrated in FIG. 2(b). Further, the recording unit 10 records a sale item database 101 as illustrated in FIG. 2(b). The sale item database 101 is a database in which sale item information (including a price) of an item for sale identified by a sale item ID is recorded for each sale item ID. These various data and information included in the customer database 100 and the sale item database 101 are transmitted to each electronic shelf label T through the transmission/reception unit 12 at the timing described later.

Finally, a detailed configuration of the terminal apparatus P according to the embodiment will be described with reference to FIG. 3. Further, the terminal apparatus P according to the embodiment is an apparatus carried by a customer identified by the customer ID described above, and specifically, the terminal apparatus P is an apparatus configured as, for example, a mobile phone or a tablet-type terminal apparatus.

As shown in FIG. 3, each of the terminal apparatuses P according to the embodiment consists of a transmission/reception unit 15 that is connected to the electronic shelf label T by wireless communication through an antenna ATP, a processing unit 16 consisting of a CPU, a RAM, a ROM, and the like, a non-volatile recording unit 17 consisting of, for example, a solid-state memory, a display 18 consisting of, for example, a liquid crystal display, and an operation unit 19 consisting of operation buttons or a touch panel.

In this configuration, the transmission/reception unit 15 transmits and receives information to and from the electronic shelf label T by the wireless communication through the antenna ATP under control of the processing unit 16. At this time, in a case that the transmission/reception unit 15 enters a range which wireless communication waves of any one of the electronic shelf labels T reach, the transmission/reception unit 15 transmits and receives information to and from the electronic shelf label T by the wireless communication. On the other hand, the display 18 displays necessary information as the terminal apparatus P and also displays the sale item information and the like provided to a customer by the information providing process according to the embodiment described later under control of the processing unit 16. Then the processing unit 16 integrally controls the recording unit 17, the transmission/reception unit 15, and display 18 on the basis of an operation of the customer at the operation unit 19, and performs the information providing process described later as the terminal apparatus P according to the embodiment. At this time, the recording unit 17 stores a customer ID 170 for identifying the customer who carries the terminal apparatus P in a non-volatile manner. Then, as part of the information providing process, the processing unit 16 transmits the customer ID 170 to the electronic shelf label T through the transmission/reception unit 15 at the timing described later.

Next, the information providing process according to the embodiment will be specifically described with reference to FIGS. 4 to 11. Further, the information providing process described below is performed mainly by the processing unit 3 of the electronic shelf label T, the processing unit 11 of the server apparatus SV, and the processing unit 16 of the terminal apparatus P.

First, as the information providing process according to the embodiment, a process in the electronic shelf label T will be specifically described with reference to FIG. 4.

As shown in FIG. 4, in the information providing process according to the embodiment, when, for example, a power supply of the electronic shelf label T is turned on, the processing unit 3 of the electronic shelf label T starts monitoring whether or not any one of the terminal apparatuses P enters the communicable range of the electronic shelf label T (in other words, whether or not the terminal apparatus P is detected in the communicable range) (step S1). In a case that the terminal apparatus P is not detected in the monitoring in step S1 (step S1; NO), the processing unit 3 determines whether or not the power supply of the electronic shelf label T is turned off (step S7), and if the power supply is turned off (step S7; YES), the processing unit 3 ends the information providing process according to the embodiment as the electronic shelf label T without change. On the other hand, in a case that the power supply is not turned off in the determining in step S7 (step S7; NO), the processing unit 3 returns to the monitoring in step S1 described above.

On the other hand, in a case that the terminal apparatus P is detected in the monitoring in step S1 (step S1; YES), the customer ID 170 is transmitted from the terminal apparatus P. Therefore, the processing unit 3 of the electronic shelf label T receives this, transmits minimum sale item information including the price and the like displayed on the display 5 at that time to the terminal apparatus P, and causes the display 18 of the terminal apparatus P to display the sale item information (step S2). Thereby, the processing unit 3 adds time data indicating the receiving time of the customer ID 170 to the received customer ID 170 to form the customer/time data 21 and transmits the customer/time data 21 and the sale item ID 20 to the server apparatus SV (step S3).

Subsequently, the processing unit 3 monitors whether or not the processing unit 3 receives sale item information to be transmitted to the terminal apparatus P that has transmitted the customer ID 170 in the process of step S2 described above from the server apparatus SV (step S4). In a case that the processing unit 3 does not receive the sale item information from the server apparatus SV in the monitoring in step S4 (step S4; NO), the processing unit 3 proceeds to the process of step S7 described above and the following process. On the other hand, in a case that the processing unit 3 receives the sale item information from the server apparatus SV in the monitoring in step S4 (step S4; YES), next, the processing unit 3 determines whether or not the terminal apparatus P that is the transmission destination of the received sale item information (that is, the terminal apparatus P that has transmitted the customer ID 170 in the process of step S2 described above) is still detected in the communicable range of the electronic shelf label T (step S5). In a case that the processing unit 3 can detect the terminal apparatus P in the determining in step S5 (step S5; YES), the processing unit 3 transmits the sale item information to the terminal apparatus P through the transmission/reception unit 1 and the antenna ATT (step S6). Thereafter, the processing unit 3 proceeds to the process of step S7 described above and the following process. Further, in a case that the processing unit 3 cannot detect the terminal apparatus P in the determining of step S5 described above (step S5; NO), the processing unit 3 also proceeds to the process of step S7 described above and the following process.

Next, as the information providing process according to the embodiment, a process in the server apparatus SV will be specifically described with reference to FIG. 5.

As shown in FIG. 5, in the information providing process according to the embodiment, when, for example, a power supply of the server apparatus SV is turned on, the processing unit 11 of the server apparatus SV monitors whether or not the customer/time data 21 and the sale item ID 20 are transmitted from any one of the electronic shelf labels T (step S10, see step S3 in FIG. 4). In a case that the customer/time data 21 and the sale item ID 20 are not transmitted in the monitoring in step S10 (step S10; NO), the processing unit 11 determines whether or not the power supply of the server apparatus SV is turned off (step S14), and if the power supply is turned off (step S14; YES), the processing unit 11 ends the information providing process according to the embodiment as the server apparatus SV without change. On the other hand, in a case that the power supply is not turned off in the determining in step S14 (step S14; NO), the processing unit 11 returns to the monitoring in step S10 described above.

On the other hand, in a case that the customer/time data 21 and the sale item ID 20 are transmitted from any one of the electronic shelf labels T in the monitoring in step S10 (step S10; YES), the processing unit 11 adds the received customer/time data 21 to the customer database 100 in the recording unit 10 while referring to the sale item ID 20 transmitted at the same time and generates sale item information to be transmitted to the terminal apparatus P detected in the monitoring in step S1 in FIG. 4 (step S11). Specific processing contents of the generation of the sale item information in this step S11 will be described later in detail. Subsequently, the processing unit 11 determines whether or not it is the timing to transmit the sale item information to the electronic shelf label T and causes the electronic shelf label T to provide the sale item information to the terminal apparatus P on the basis of contents of the generated sale item information and the like (step S12). In a case that the processing unit 11 does not transmit the sale item information to the electronic shelf label T in the determination in step S12 (step S12; NO) because of a reason such as that it is not the timing to provide the generated sale item information, the processing unit 11 proceeds to the process of step S14 described above and the following process.

In a case that the processing unit 11 transmits the sale item information to the electronic shelf label T in the determination in step S12 (step S12; YES) because it is the timing to provide the generated sale item information, the processing unit 11 transmits the sale item information to the electronic shelf label T and causes the electronic shelf label T to transmit the sale item information to the corresponding terminal apparatus P (step S13, see steps S4 to S6 in FIG. 4). Thereafter, the processing unit 11 proceeds to the process of step S14 described above and the following process.

Next, as a process according to step S11 described above, such as a generation process of the sale item information provided to the customer who carries the terminal apparatus P will be described while illustrating the process with reference to FIGS. 6 to 10.

As a first example, as a result of searching the customer database 100 by using a type of item for sale as a keyword (see step S11 in FIG. 5) about a customer whose customer ID 170 is “20130206”, as illustrated in FIG. 6, it is assumed that data indicating items for sale of different brands of the same type in a relatively short time period (milk A to milk D in the illustration in FIG. 6) is searched. In this case, it is assumed that the customer wants to purchase a certain type of item for sale (“milk” in the case illustrated in FIG. 6), but wonders what brand of item for sale to purchase. Then, in this case, the processing unit 11 of the server apparatus SV searches the sale item database 101 and extracts sale item information indicating a recommended item for sale set in advance by a shop that utilizes the server apparatus SV, and then immediately transmits the sale item information to the electronic shelf label T (see step S12; YES and step S13 in FIG. 5). As a result of this, when the sale item information is transmitted to the terminal apparatus P through the electronic shelf label T (see step S6 in FIG. 4), the sale item information as illustrated at lower right in FIG. 6 is timely displayed on the display 18 of the terminal apparatus P.

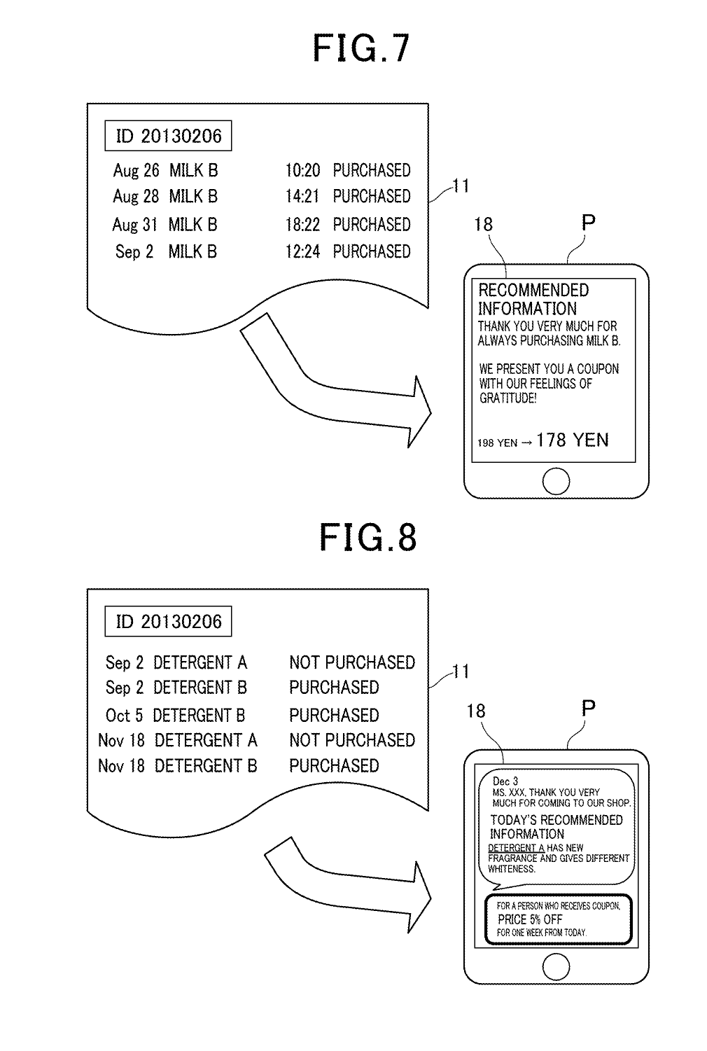

As a second example, as a result of searching the customer database 100 by using a specific brand of item for sale as a keyword (see step S11 in FIG. 5) about the customer whose customer ID 170 is the same “20130206”, as illustrated in FIG. 7, it is assumed that data indicating items for sale of the same brand in a relatively long time period (milk B in the illustration in FIG. 7) is searched. In this case, it is assumed that the customer is a customer who always purchases the brand of item for sale (“milk B” in the illustration in FIG. 7). Then, in this case, the processing unit 11 of the server apparatus SV searches the sale item database 101 and extracts sale item information including discount information and coupon information that are focused on customers of the brand of items for sale (so-called “regular customers”) by a shop that utilizes the server apparatus SV, and then immediately transmits the sale item information to the electronic shelf label T (see step S12; YES and step S13 in FIG. 5). As a result of this, when the sale item information is transmitted to the terminal apparatus P through the electronic shelf label T (see step S6 in FIG. 4), the sale item information including discount information and coupon information as illustrated at lower right in FIG. 7 is timely displayed on the display 18 of the terminal apparatus P.

Next, as a third example, as a result of searching the customer database 100 by using a type of item for sale as a keyword (see step S11 in FIG. 5) about the customer whose customer ID 170 is the same “20130206”, as illustrated in FIG. 8, it is assumed that data indicating one item for sale (“detergent B” in the illustration in FIG. 8) of the same type (“detergent” in the illustration in FIG. 8) of different items for sale (“detergent A” and “detergent B” in the illustration in FIG. 8) is purchased at substantially equal intervals (about one month in the illustration in FIG. 8). Further, at this time, it is assumed that the detergent A is a new product and the detergent B is a conventional product, so that the sale of the detergent A is promoted. In this case illustrated in FIG. 8, it is known that the sale item ID 20 indicating the detergent A and the sale item ID 20 indicating the detergent B are transmitted at substantially the same timing from the electronic shelf labels T corresponding to the detergents A and B, respectively, and the detergent A is not purchased. Therefore, in this case, it is assumed that the customer compares the detergent A and the detergent B and finally purchases the detergent B even though being interested in the detergent A. Therefore, in such a case, to advertise the detergent A, which is a new product, at the next purchasing time of the detergent B, for example, in a period (for example, in one week before and after the next purchasing time) before and after the time assumed to be the next purchasing time (the beginning to the middle of December in the illustration in FIG. 8), when the customer comes to the shop and sale item information is transmitted to the terminal apparatus P carried by the customer from any one of the electronic shelf labels T in the shop, the processing unit 11 of the server apparatus SV transmits sale item information, coupon information, and the like of the detergent A to the electronic shelf label T on the basis of the customer ID 170 transmitted from the electronic shelf label T to the server apparatus SV (see step S12; YES and step S13 in FIG. 5). As a result of this, when the sale item information, the coupon information, and the like are transmitted to the terminal apparatus P through the electronic shelf label T (see step S6 in FIG. 4), the sale item information as illustrated at lower right in FIG. 8 is timely displayed on the display 18 of the terminal apparatus P. In the illustration at lower right in FIG. 8, “December 3” that is the next visit date (the next purchasing time) and a customer name (“XXX”) corresponding to the customer ID 170 are displayed and in addition to these, the sale item information and the coupon information are displayed.

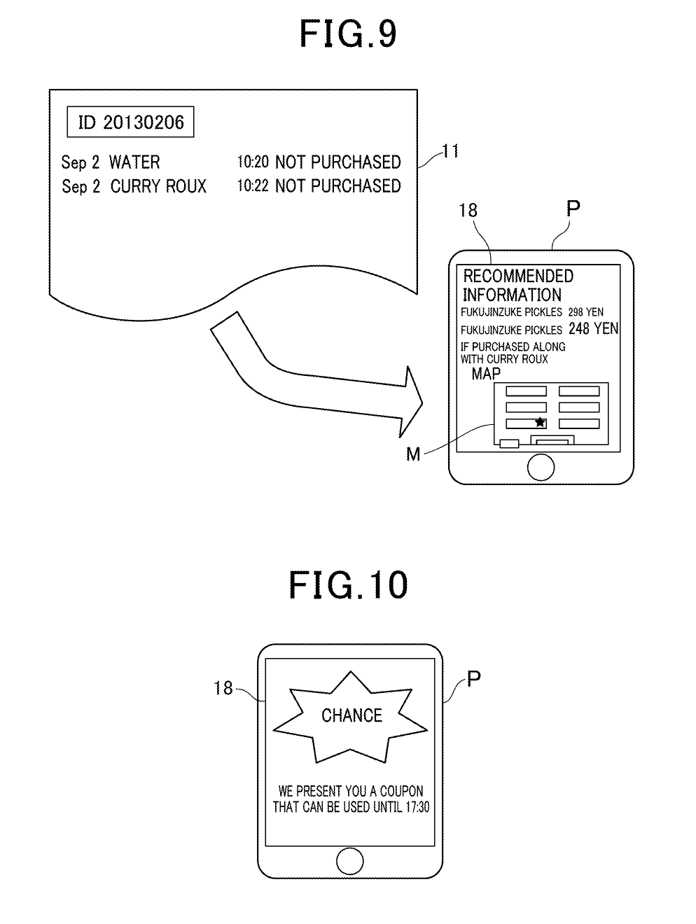

As a fourth example, as a result of searching the customer database 100 about the customer whose customer ID 170 is the same “20130206” (see step S11 in FIG. 5), as illustrated in FIG. 9, if data indicating a plurality of types of different items for sale (“water” and “curry roux” in the illustration in FIG. 8) in a relatively short time period is searched and the fact that the customer has not yet passed through the register is detected, it is assumed that the customer is a customer who is shopping while thinking of a menu of a dinner. Then, in this case, the processing unit 11 of the server apparatus SV searches the sale item database 101 and extracts sale item information (coupon information) determined in advance by a shop that utilizes the server apparatus SV, such as sale item information indicating that a good bargain can be made by a recipe or a combination including the searched item for sale (for example, when a set of an item for sale A (for example, the curry roux) and an item for sale B (for example, Fukujinzuke pickles) is purchased, the set is discounted), and then immediately transmits the sale item information to the electronic shelf label T (see step S12; YES and step S13 in FIG. 5). As a result of this, when the sale item information is transmitted to the terminal apparatus P through the electronic shelf label T (see step S6 in FIG. 4), the sale item information as illustrated at lower right in FIG. 8 is timely displayed on the display 18 of the terminal apparatus P. In the case of the illustration in FIG. 8, it is preferable to display the sale item information with a map M that indicates the position where a target item for sale is displayed in the shop.

Here, regarding what search method from among the first to the fourth examples is used to search the customer database 100 and the sale item database 101, for example, the searches may be performed simultaneously in parallel or may be performed sequentially at predetermined time intervals.

As each described above, according to the information providing process of the information providing system S according to the present embodiment, while the sale item information such as the price is displayed by using the display 5 of the electronic shelf label T, the electronic shelf label T receives the customer ID 170 of the customer who sees the sale item information from the terminal apparatus P through wireless communication and the customer/time data 21 in which the customer ID 170 is associated with time data indicating the receiving time of the customer ID 170 is recorded. Then, the recorded customer/time data 21 is associated with the sale item ID 20 and the customer/time data 21 and the sale item ID 20 are transmitted to the server apparatus SV. Therefore, the server apparatus SV acquires the time data, the customer ID 170, and the article identification information from the electronic shelf label T while associating the time data, the customer ID 170, and the article identification information with each other, so that it is possible to provide various information to the customer identified by the customer ID 170 by using the acquired customer ID 170 and the like. Further, the server apparatus SV can acquire the time data, the customer ID 170, and the sale item ID 20, which are associated with each other, so that the server apparatus SV can acquire and record various information indicating a moving state of the customer such as a traffic line of the customer without separately acquiring the customer ID 170 again.

More specifically, for example, it can be configured to increase purchasing desire of the customer by displaying “time-limed coupon information” as illustrated in FIG. 10 at timing before the customer passes through the register according to the moving state of the customer. Further, as illustrated in FIG. 11, for example, the server apparatus SV can record information such as “positions which a customer who does not pass through a register RG passes through in an area from a display shelf SC1 to a display shelf SC6 in a shop SP and moves to an entrance door ET”. In the case illustrated in FIG. 11, it is possible to record data indicating that a customer moves from the start position (A) to the end position (D) as shown by the dashed lines along with time data indicating the time when the customer comes to each position and the customer ID 170 in the recording unit 10 of the server apparatus SV as the customer database 100. Data indicating such a moving state may be very useful data for the shop when reviewing, for example, display positions and display methods of items for sale or widths of passages.

Further, the electronic shelf label T is provided for each item for sale on each display shelf and the customer ID 170 is received from the terminal apparatus P of a customer who passes through in front of the display shelf, so that it is possible to effectively provide various information to, for example, a customer coming for shopping. Further, it is possible to associate the customer ID 170 of the customer who passes through in front of the display shelf with the time data indicating the time of the passing, store the customer ID 170 and the time data, further associate the customer ID 170 and the time data with the sale item ID 20, and transmit the customer ID 170, the time data, and the sale item ID 20 to the server apparatus SV.

Further, in a case that the transmission and reception of information between the terminal apparatus P carried by the customer and the electronic shelf label T is performed by wireless communication compliant with the NFC standard, it is possible to receive the customer ID 170 with an inexpensive and simple configuration by using a general standard. The wireless communication standard in this case is not limited to the NFC standard, but may be a so-called wireless LAN (Local Area Network) standard or a standard similar to the wireless LAN standard if it is a wireless communication standard used for relatively short distance communication.

Further, when the display 5 of the electronic shelf label T is formed by an electronic paper, it is possible to effectively utilize advantages of the electronic paper by minimizing rewriting of the sale item information on the electronic paper.

Further, the server apparatus SV receives and records the customer/time data 21 and the sale item ID 20 transmitted from the electronic shelf label T, generates sale item information based on the recorded data, and provides the sale item information to the customer, so that it is possible to efficiently provide sale item information of, for example, an item for sale according to a preference of the customer.

Further, the sale item information provided to the customer is related to an item for sale identified by the sale item ID 20, so that it is possible to provide information suitable for the customer who is provided with the sale item information related to the item for sale.

Further, in the case illustrated in FIG. 6, it is possible to effectively provide sale item information according to a purchase state including a purchase history of items for sale of different brands of the same type to the customer.

Further, in the case illustrated in FIG. 7, it is possible to effectively provide sale item information according to a purchase state including a purchase history of items for sale of the same brand to the customer.

Further, in the case illustrated in FIG. 8, it is possible to effectively provide sale item information according to an item for sale recommended to be purchased at the same time to the customer.

Further, in the embodiment described above, even sale item information other than the price is transmitted to the terminal apparatus P carried by the customer through the electronic shelf label T. However, for example, in a case that sale item information with a large amount of data is required to be provided to the customer through the terminal apparatus P, as shown in an information providing system SS illustrated in FIG. 12, it is possible to configure to transmit the sale item information with a large amount of data from the server apparatus SV to the terminal apparatus P by wireless or wired communication through the network NW such as the Internet. Further, it may be configured so that information indicating the location of the sale item information on the network NW is transmitted to the terminal apparatus P by, for example, e-mail, and the terminal apparatus P that receives the information acquires the sale item information by using the information indicating the location of the sale item information. In these cases, it is possible to minimize rewriting of the sale item information to be displayed on the electronic shelf label T by providing various other sale item information not through the electronic shelf label T, so that it is possible to more effectively utilize advantages of the case in which the display 5 of the electronic shelf label T is formed by an electronic paper.

In the embodiment described above, the present invention is applied to items for sale to be sold. However, besides the above, the present invention can be applied to a case in which, for example, sales promotion materials, which are not sold, are delivered.

Further, it is possible to cause a microcomputer or the like to function as the processing unit 3 and the processing unit 11 according to the embodiment by recording programs corresponding to the flowcharts shown in FIGS. 4 and 5 respectively in a recording medium such as an optical disk or acquiring and recording the programs through the network NW, and causing the microcomputer or the like to read and execute the programs.

### INDUSTRIAL APPLICABILITY

As described above, the present invention can be used in a field of an information providing system. In particular, when the present invention is applied to a field of an information providing system that provides sale item information related to items for sale displayed in a shop, especially remarkable effects are obtained.

### DESCRIPTION OF REFERENCE NUMERALS

1, 4, 12, 15: Transmission/reception unit
2, 10, 17: Recording unit
5, 18: Display
3, 11, 16: Processing unit
19: Operation unit
20: Sale item ID
21: Customer/time data
100: Customer database
101: Sale item database
170: Customer ID
S, SS: Information providing system
T, T1, T2, T3, Tn: Electronic shelf label
SV: Server apparatus
P, P1, Pm: Terminal apparatus
ATT, ATP: Antenna
M: Map
RG: Register
SP: Shop
SC1, SC2, SC3, SC4, SC5, SC6: Display shelf
ET: Entrance door
NW: Network

1. An information outputting apparatus comprising:
an outputting means that outputs article information related to an article;
a receiving means that receives user identification information for identifying a user, who receives an output of the article information, from a user apparatus of the user by wireless communication;
a storing means that stores time information indicating time when the user identification information is received and the received user identification information in association with each other; and
a transmitting means that associates the time information and the user identification information, which are stored in association with each other, with article identification information for identifying the article and outputs the time information, the user identification information, and the article identification information to outside.

2. The information outputting apparatus according to claim 1, wherein
the information outputting apparatus is a shelf label provided to a display shelf on which the article related to the outputted article information is displayed, and
the receiving means receives the user identification information from the user apparatus of the user who moves in front of the display shelf.

3. The information outputting apparatus according to claim 1, wherein
the receiving means receives the user identification information from the user apparatus by the wireless communication compliant with NFC (Near Field Communication) standard.

4. The information outputting apparatus according to claim 1, wherein
the outputting means outputs the article information by using an electronic paper.

5. An information outputting system comprising: the information outputting apparatus according to claim 1 and a server apparatus, wherein
the server apparatus comprises
a server apparatus receiving means that receives the time information, the user identification information, and the article identification information which are transmitted from the information outputting apparatus,
a server apparatus storing means that stores the received time information, user identification information, and article identification information,
a generating means that generates provision information to be provided to the user identified by the user identification information on the basis of the stored time information, user identification information, and article identification information, and
a providing means that provides the generated provision information to the user identified by the user identification information.

6. The information outputting system according to claim 5, wherein
the generating means generates the provision information according to time intervals indicated by a plurality of the time information of the same article or a related article and a purchase state of the article on the basis of the stored time information, user identification information, and article identification information.

7. The information outputting system according to claim 5, wherein
the provision information is related to the article identified by the article identification information.

8. The information outputting system according to claim 5, wherein
the generating means generates the provision information according to a purchase state of the articles of different brands of the same type on the basis of the stored time information, user identification information, and article identification information.

9. The information outputting system according to claim 5, wherein
the generating means generates the provision information according to a purchase state of the article of the same brand on the basis of the stored time information, user identification information, and article identification information.

10. The information outputting system according to claim 5, wherein
the generating means generates the provision information according to the article recommended for the user to purchase at the same time on the basis of the stored time information, user identification information, and article identification information.

11. The server apparatus included in the information outputting system according to claim 5, the server apparatus comprising:
the server apparatus receiving means;
the server apparatus storing means;
the generating means; and
the providing means.

12. An information outputting method included in an information outputting system comprising an information outputting apparatus comprising an outputting means that outputs article information related to an article and a storing means, and a server apparatus comprising a server apparatus storing means, the information outputting method comprising:
a receiving step of receiving user identification information for identifying a user, who receives an output of the article information, from a user apparatus of the user by wireless communication, in the information outputting apparatus;
a storing step of causing the storing means to store time information indicating time when the user identification information is received and the received user identification information in association with each other, in the information outputting apparatus;
a transmitting step of associating the time information and the user identification information, which are stored in association with each other, with article identification information for identifying the article and outputting the time information, the user identification information, and the article identification information to the server apparatus, in the information outputting apparatus;
a server apparatus receiving step of receiving the time information, the user identification information, and the article identification information which are transmitted from the information outputting apparatus, in the server apparatus;
a server apparatus storing step of causing the server apparatus storing means to store the received time information, user identification information, and article identification information, in the server apparatus;
a generating step of generating provision information to be provided to the user identified by the user identification information on the basis of the stored time information, user identification information, and article identification information, in the server apparatus; and
a providing step of providing the generated provision information to the user identified by the user identification information, in the server apparatus.

13. A non-transitory recording medium which records a program for information outputting apparatus, the program causing a computer included in the information outputting apparatus comprising an outputting means that outputs article information related to an article, a receiving means that receives user identification information for identifying a user, who receives an output of the article information, from a user apparatus of the user by wireless communication, and a storing means, to function as:
a storing control means that causes the storing means to store time information indicating time when the user identification information is received and the received user identification information in association with each other; and
a transmitting means that associates the time information and the user identification information, which are stored in association with each other, with article identification information for identifying the article and outputs the time information, the user identification information, and the article identification information to outside.

14. A non-transitory recording medium which records a program for server apparatus, the program causing a computer included in the server apparatus which is connected to the information outputting apparatus according to claim 1 and which comprises a server apparatus storing means to function as:
a server apparatus receiving means that receives the time information, the user identification information, and the article identification information which are transmitted from the information outputting apparatus;
a storing control means that causes the server apparatus storing means to store the received time information, user identification information, and article identification information;
a generating means that generates provision information to be provided to the user identified by the user identification information on the basis of the stored time information, user identification information, and article identification information; and
a providing means that provides the generated provision information to the user identified by the user identification information.

15. The information outputting apparatus according to claim 2, wherein
the receiving means receives the user identification information from the user apparatus by the wireless communication compliant with NFC (Near Field Communication) standard.

16. The information outputting apparatus according to claim 2, wherein
the outputting means outputs the article information by using an electronic paper.

17. An information outputting system comprising: the information outputting apparatus according to claim 2 and a server apparatus, wherein
the server apparatus comprises
a server apparatus receiving means that receives the time information, the user identification information, and the article identification information which are transmitted from the information outputting apparatus,
a server apparatus storing means that stores the received time information, user identification information, and article identification information,
a generating means that generates provision information to be provided to the user identified by the user identification information on the basis of the stored time information, user identification information, and article identification information, and
a providing means that provides the generated provision information to the user identified by the user identification information.

18. The information outputting system according to claim 6, wherein
the provision information is related to the article identified by the article identification information.

19. The information outputting system according to claim 6, wherein
the generating means generates the provision information according to a purchase state of the articles of different brands of the same type on the basis of the stored time information, user identification information, and article identification information.

20. The information outputting system according to claim 6, wherein
the generating means generates the provision information according to a purchase state of the article of the same brand on the basis of the stored time information, user identification information, and article identification information.
